(19) United States
(12) Patent Application Publication
(10) Pub. No.: US 2016/0048850 A1
(43) Pub. Date: Feb. 18, 2016

(54) COLLECTING, AGGREGATING, ANALYZING AND REPORTING TRACTION DATA ON INTERNET-CONNECTED APPLICATIONS

(71) Applicant: Clarence Wooten, Palo Alto, CA (US)

(72) Inventor: Clarence Wooten, Palo Alto, CA (US)

(21) Appl. No.: 14/827,178

(22) Filed: Aug. 14, 2015

Related U.S. Application Data
(60) Provisional application No. 62/037,890, filed on Aug. 15, 2014.

(51) Int. Cl. G06Q 30/02; H04L 12/26

(52) U.S. Cl. CPC G06Q 30/0201; H04L 43/062

(57) ABSTRACT

Described is a way to improve efficiency in relaying software application traction data from developers to interested parties. Traction data is collected from a plurality of software applications through analytics modules. The traction data is forwarded in real-time to a network server which in turn aggregates and publishes the data in an indexed live feed. Within the live feed are controls for both subscribers and applications owners. Subscribers are enabled to configure threshold alerts concerning predetermined traction criterion. Application owners are enabled to determine which subscribers have access to traction data concerning their software application.

### CLAIM FOR PRIORITY

This application claims priority to U.S. Provisional Patent Application No. 62/037,890 entitled “SYSTEM AND METHOD FOR COLLECTING, AGGREGATING, ANALYZING AND REPORTING TRACTION DATA ON INTERNET-CONNECTED APPLICATIONS” filed Aug. 15, 2014. The 62/037,890 application is incorporated by reference in its entirety.

### TECHNICAL FIELD

Embodiments relate generally to tracking and monitoring both external and internal growth-related data and metrics of software applications, including Internet-based and mobile software applications.

### BACKGROUND

Internet and mobile software applications are easy to develop and bring to market. The glut of new software entering the market has caused investors to take a wait-and-see approach before investing. This wait-and-see approach has increased what software entrepreneurs must accomplish before they can attract substantial investments.

Demand is typically demonstrated by growth and sustainability metrics, including among other things the number and growth-rate and stability of new visitors, downloads, application installs, signups and revenue growth, which are known collectively and individually as “traction data.” The process of aggregating and pitching growth-data to potential investors is very time-consuming and distracting for entrepreneurs and investors alike.

### BRIEF DESCRIPTION OF FIGURES

FIG. 1 is a block diagram of a an embodiment of a processing device within a computing system, which can implement the techniques introduced here;

FIG. 2 is a diagram of a traction data-processing system, according to various embodiments;

FIG. 3 is a diagram of a traction data-processing system with an alternate application software configuration, according to various embodiments;

FIG. 4 is a flowchart illustrating an example of a process of an app owner signing up for a traction data reporting service by integrating the above-described analytics interface into the app owner's software application;

FIG. 5 is a flowchart illustrating a process of collecting and presenting traction data associated with a software application;

FIG. 6 is a flowchart illustrating permissions and actions for multiple levels of user accounts; and

FIG. 7 is a chart diagram illustrating one embodiment of a real-time live feed focusing on an individual application wherein an application owner has annotated the data.

### DETAILED DESCRIPTION

Software entrepreneurs are required to build their software application and show growth-traction in order to convince investors that there is proven demand for their software application. Most software entrepreneurs over-value their software applications, and because of risk aversion related to lack of data, most investors under-value most software applications. At present, due to the entrenched protocol and hierarchy of how investors interact with entrepreneurs and other investors, entrepreneurs are required to perform all of the work of capturing growth-traction in snapshots.

In most cases most institutional investors such as venture capitalists do not share such data with each other, even when presented with traction-data, investors lack comparative aggregate benchmarking data to form an opinion on how attractive the early traction data is in comparison to similar software startup companies.

To resolve this problem, described herein is a way to collect, aggregate, analyze and report traction data on Internet-connected software applications. It is further useful to include functionality which compares and ranks the traction data to industry norms.

Traction data is a set of key performance indicators (KPIs) that show whether a software application (“app”) has momentum in the marketplace. Traction data can be a combination of any one or more of the following KPIs, which are indicative of the monetary, intrinsic, relative, subjective and/or objective value of a software application, especially (though not necessarily) when aggregated and compared to other software applications, either globally or according to geography, industry, application, feature set, user demographic etc.:
Number of times a software application or marketing site is visited by users or potential users;
Period of time a software application is used by users;
Number of software application downloads by a plurality of users;
Number of software application accounts that are created by users;
Number of software application accounts that are deactivated by users;
Number of software application logins that are implemented by users;
Number of other persons who are invited by one or more users to visit or create and account for a software application;
Number of new purchases, subscriptions and/or upgrades for a software application are completed by users;
Number of subscription renewals that are either completed by users and/or number of subscription renewal that are automatically implemented by the software application for users; and
Number of application specific user actions undertaken by users.

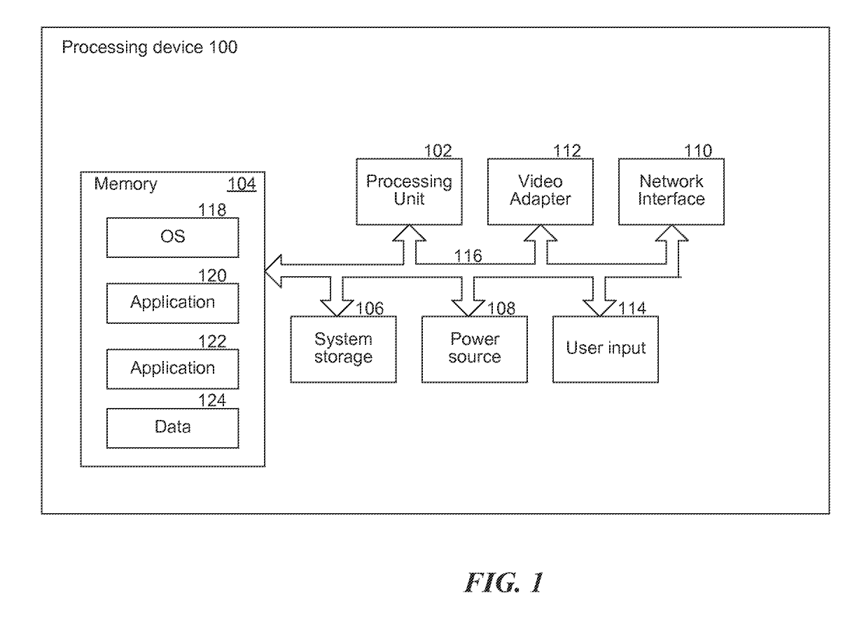

FIG. 1 is a block diagram of a an embodiment of a processing device within a computing system, which can implement the techniques introduced here. The following discussion is intended to provide a brief, general description of suitable computing environments in which the system and method may be implemented. Although not required, the disclosed embodiments will be described in general context of computer-executable instructions, such as program modules, being executed by one or more computers.

A processing device 100 includes several components. Components include: a processor 102, a memory 104, a system storage (hard disk or suitable long term storage) 106, a power source 108, a network interface 110, a video interface 112, and a user input 114 all connected by a communications BUS 116. The memory 104 storing an operating system 118, a number of applications 120,122, and other assorted data 124. Software and/or data used to implement the techniques introduced here can be stored in memory 104 and/or system storage 106.

Generally, computer programs include, but are not limited to, routines, subroutines, software applications, program, objects, components, data structures, etc. that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor based or programmable consumer electronics, networked computers, minicomputers, mainframe computers, servers and the like.

The term “modules” as used herein may refer to a collection of routines and data structures that perform a particular task or implements a particular abstract data type. Modules may be composed of two parts—an interface, which lists the constants, data types, variables, and routines that can be accessed by other modules or routines, and an implementation, which is typically private (i.e. accessible to only that module) and which includes source code that actually implements the routines in the module. The term module may also simply refer to an application, such as a computer program designed to assist in the performance of a specific task, such as word processing, accounting, inventory management, etc.

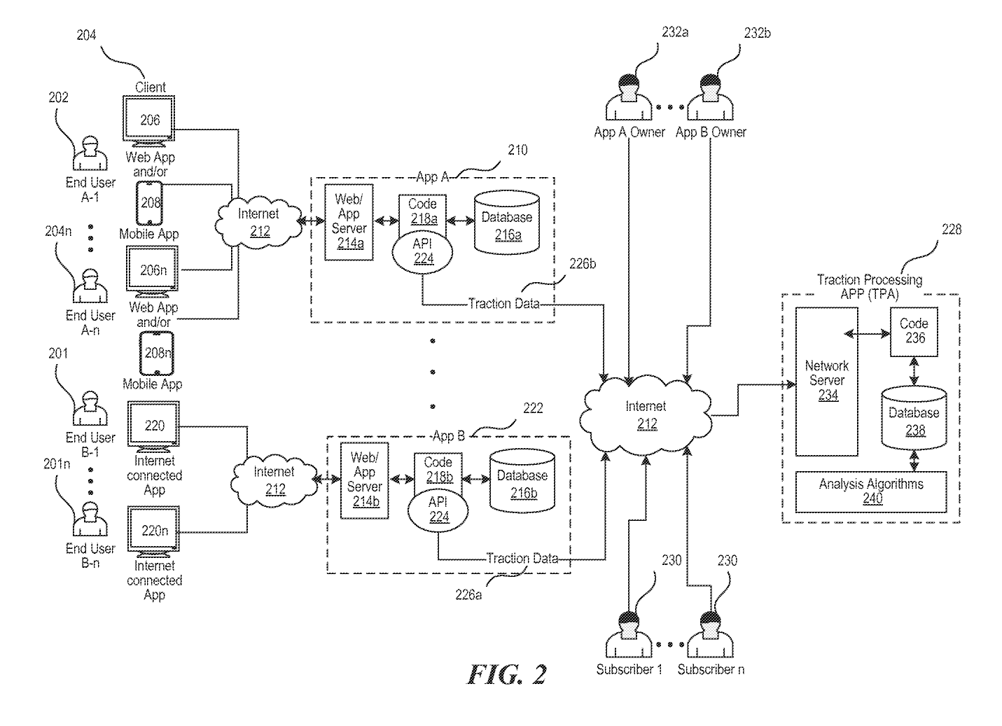

FIG. 2 is a diagram of a traction data-processing system, according to various embodiments. The disclosed embodiments can be implemented in the context of data-processing systems connected over the Internet. A plurality of end users 202 to 202N use resident software applications (also known as clients) 204 accessed through processing devices (such as laptop computers, desktop computers, kiosks and/or dedicated monitors) 206 and 206n and/or mobile devices (such as smartphones, tablets, phablets, and/or remote control devices) 208 and 208n. The clients 200 are used to implement, access, and use, through the Internet 212, a software application A 210 residing on application server 214a and database 216a supported by code 218a.

Similarly, a plurality of end users 201 to 201N use Internet-connected software applications or clients 200 resident on Internet-connected dedicated computers or computers connected to physical devices (for example, refrigerators, coffee makers, automobiles etc.) 220 to 220n. In some embodiments, these software applications or clients may partly reside in the computers 220 to 220n and partly or wholly reside in the owner's software application B 222. The physical devices 220 to 220n are used to implement, access, and use, through the Internet 212, the software application B 222 residing on application server 214b and database 216b supported by code 218b.

With reference to both software application A 210 and software application B 222 above, an analytics interfaces collects fraction data. Examples of an analytics interface include an application program interface (API) 224, which is implemented by (i.e., integrated and written into) the application code 218a and 218b of the software application A 210 and software application B 222 respectively.

Traction data for each user 202 to 202n and 201 to 201n are transferred over the internet 212 respectively and received by the a network server 214a and 214b respectively.

With each of the devices discussed above, the traction data 226 is then transferred in real-time, daily, or in accordance with bandwidth restrictions, over the internet 212 to the traction processing application (TPA) 228 and/or stored in the databases 216a, 216b respectively and later transferred over the Internet 212 to the TPA 228. An example of data transmission protocol includes JSON and/or other compact data-transfer protocols. JSON (JavaScript Object Notation) is a lightweight data-interchange format that is easy for computers to parse and generate. It is based on a subset of the JavaScript Programming Language, Standard ECMA-262 3rd Edition—December 1999.

The analytics interface transmits traction data to the TPA 228 where the traction data is received by a network server 234. The TPA 228 includes code 236 which performs numerous functions upon the fraction data. The TPA 228 aggregates traction data corresponding to a given software application if such aggregation was not already performed by the software application prior to transmission to the TPA 228. A database 238 stores aggregated traction data from each specific software application 210, 222. The TPA 228 further aggregates the traction data from a plurality of software applications (e.g., all of the software applications for which traction data was provided), or based on geography, industry, application, feature set, user demographic etc. and stores such aggregated data in the database 238. Algorithms 240 within the TPA 228 analyze the aggregate traction data to generate reports, a GUI dashboard, or a live-feed that compare the aggregate traction data to individual traction data for a specific software applications.

The TPA 228 processes logins from software application owner(s) 232a, 232b for access to their individual reports or live-feed via the network server 234 and Internet 212. The network server 234 transfers reports, GUI dashboard, or live-feed to the individual software application owner(s) 232a, 232b, or provides access to a website. The network server 234 additionally processes logins from subscribers 230 for access to purchased or pre-approved reports, GUI dashboards, or live feed. Delivery of reports, GUI dashboards, or live feeds to subscribers 230 is similar as that to application owners 232.

A plurality of applications 210, 222 send their traction data 226 to the TPA 228 for aggregation together and with all other applications which provide data to the TPA 228, or aggregation with other similar applications (according to any relevant similarity criterion or criteria), analysis, ranking and/or valuation by the TPA 226. Owners 232a, 232b of applications 210, 222 additionally can access the TPA 226 through the Internet 212 to provide additional controls. These controls include altering the presentation of traction data related to the corresponding owned application or altering subscribers who may access the traction data associated with the corresponding owned application. The TPA 228 is includes a network server 234, containing TPA code 236, and a records database 238. The TPA 228 further invokes use of analysis algorithms 240.

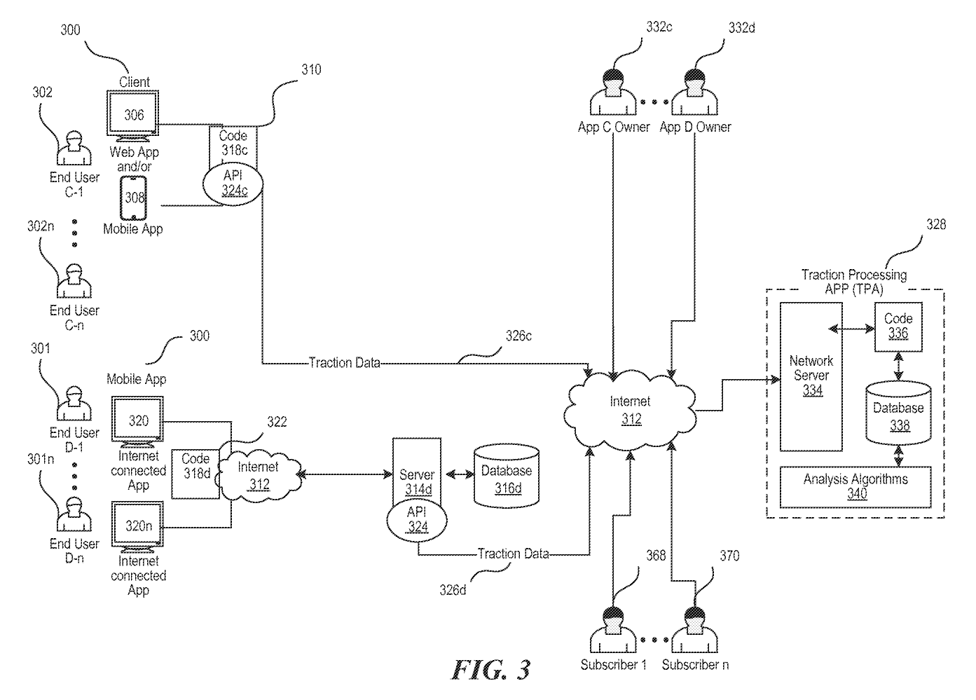

FIG. 3 is a diagram of a traction data-processing system with an alternate application software configuration, according to various embodiments. Traction data is collected from software applications, which can run on many varying platforms and software architectures. FIG. 2 depicts software architecture where the software application is broken into client and server components. FIG. 3, on the other hand, depicts two alternate configurations. A first alternate configuration is depicted by software application C 310. Application C 310 is a client application that requires minimal or no backend server application code to enable it to carry out its designed function(s). The analytics interface 324c exists on the instance of application software on the client device 300 and reports traction data 326 directly to the Internet 312 to be received by the TPA 328.

A second alternate configuration is depicted by software application D 322. Application D 322 is substantially stored and executed on a client device 300; however, additional backend server software communicates with the client application software. Here, the analytics interface 324d is instantiated on a remote server/database 314d which communicates with software application D 322 on client processing devices 300. As an illustrative example of, when an application makes use of an analytics interface which is not operated by the application owner, a backend server unrelated to the processing of the application is used to collect and forward traction data. In some embodiments, the application includes both client 300 and server 314 components but additionally transmits data to the analytics interface 324d on another server 314d. Remaining configuration and interaction depicted in FIG. 3 are similar to those in FIG. 2 as is evident.

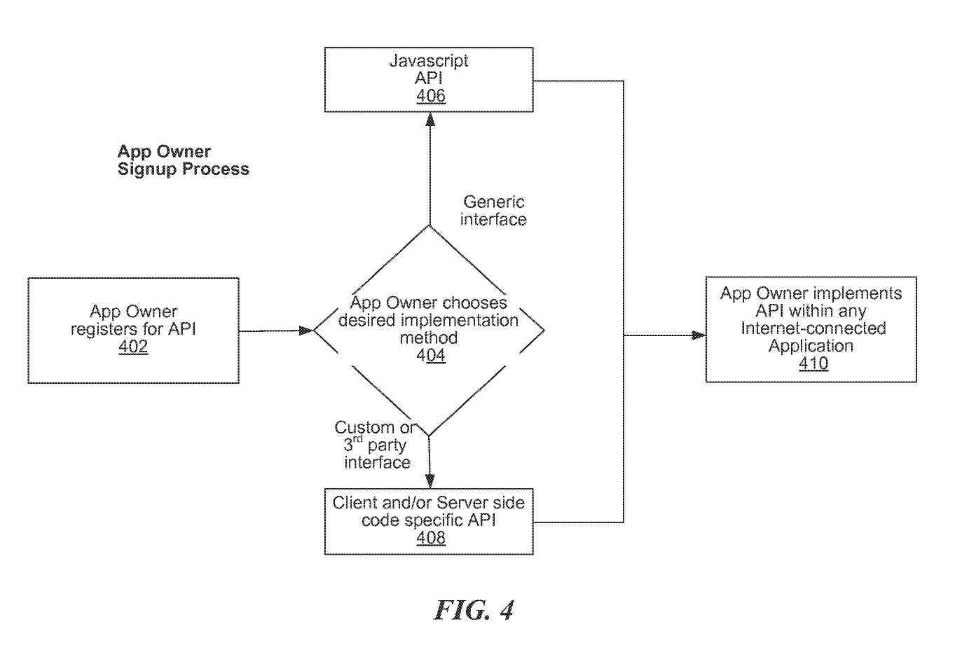

FIG. 4 is a flowchart illustrating an example of a process of an application owner signing up for a traction data reporting service by integrating the above-described analytics interface into the application owner's software application. In step 402, the owner of a given software application signs onto the TPA system and registers for a specific API based on various criteria, such as one or more of the following:
the target industry of the software application;
one or more uses for the software application;
the target demographic of the software application;
the feature set of the software application;
the geographical reach of the software application; and
which fraction data or KPIs the owner wishes to track and compare to other software applications, provided however, that in at least one embodiment, the following two KPIs are mandatory—(i) number of times a software application is visited by one or more users, and (ii) number of software application accounts that are created by one or more users.

In step 404, the application owner chooses the desired method of implementing the API, such as either through a Javascript API, or a client-resident or server-resident code-specific API. During the API registration process, each software application is provided a unique application identifier (App ID) and API Key for identification and authentication purposes when transmitting traction data over the Internet. The process of implementing the API varies depending upon the chosen method. In step 406, if implementing the Javascript API, the application owner inserts a snippet of code that implements the API along with authentication credentials including App ID into the software application.

In step 410, each time an end-user performs a given KPI associated with the software application, the API receives a request from the software application to transmit the new/updated traction data to the TPA.

In step 408, if implementing the code specific API, the application owner integrates the API implementation code directly into the backend code or within client-resident code of the application. The code-specific API communicates directly with the software application's database. In some embodiments the analytics interface generates the KPIs. In other embodiments, KPIs are generated by base application software and forwarded to the analytics interface for sorting and transmission. Predetermined traction data (KPIs), including the App ID and API Key (e.g. to authenticate and communicate securely) is transmitted directly in real-time, or in accordance with API requests, to the TPA.

In some cases, the analytics interface may be created and marketed by a party other than the application owner or the TPA administration. Additionally, embodiments of the analytics interface other than an API are contemplated. For example, an analytics interface which is a complete, standalone application may be used instead of or in addition to an API.

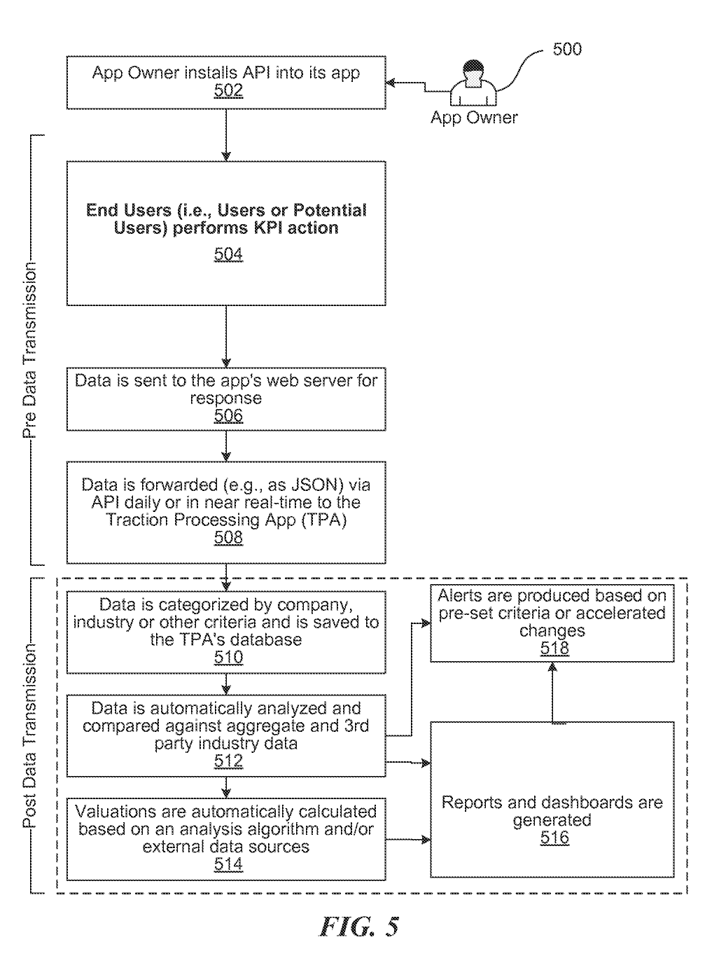

FIG. 5 is a flowchart illustrating a process of collecting and presenting traction data associated with a software application. In step 502, the software application owner integrates the chosen API into the software application, as described above. At step 504, when a user accesses and uses the owner's software application, either the analytics interface or the application itself generates KPIs. Example KPI's include: user visits to web application, application downloads, application account creation or deactivation, user log-ins, friend invites or requests, or user purchases/subscriptions, subscription renewals. KPI's combine into traction data. A user of a software application may be a registered user, paid user, free user and/or a visitor to the software application.

In step 506, the client components of the application communicates the traction data server application components. The individual user's traction data is aggregated with similar traction data resulting from other users' use/access of the software application. In some embodiments, software application architecture makes less use of server side software elements. In those embodiments, communication in step 506 is minimal or non-existent.

In step 508, The analytics interface transfers the traction data to the TPA (e.g., TPA 228 in FIG. 2) in real-time (i.e., with very little or no delay from the time the data is calculated until the time the data is sent to the TPA). Alternatively, if the software application is one that involves heavy data transmission between client and server, the analytics interface may wait for an off-hours usage period and transmit traction data on a daily basis instead of in real-time.

In step 510, traction data is received, aggregated and categorized by the TPA according to criteria described above and saved by the TPA in the TPA database. Traction data for multiple individual software applications can be saved in the TPA database in this manner for comparison. In step 512, based on one or more predetermined criteria (e.g. industry, geography, user growth, sales growth, etc.), these data are then analyzed and compared by the TPA against the aggregated traction data according to the categorization criteria described above.

In step 514, The TPA along with optional 3rd party analytics engines, calculate a subjective, objective, monetary and/or ranking value of the software application using algorithms implementing predetermined criteria, collected traction data, and external data sources (e.g. public company valuation multiples, comparable company financing valuations). The ranking(s) can be updated continually or periodically as new traction data is received for that owner's software application and other software applications within the same category or categories. In step 516, the aggregated data and the valuation data are integrated into reports, GUI dashboards, or the real-time live feed.

In step 518, the TPA generates alerts provided to particular subscribers according to criteria established by those subscribers. Example criteria include thresholds, changes, or accelerations in traction data. Alerts can appear as direct emails or flags appearing in reports, the GUI dashboard, or the real-time live feed. The subscribers may log into the TPA's reports and dashboard to review traction data that generate an alert or alerts, and compare such data to aggregated traction data from other similarly categorized software applications.

Traction data can either be (i) aggregated before being transferred to the TPA before being aggregated globally or aggregated with other similar applications, analyzed, ranked and/or valued by the TPA; or (ii) transferred to the TPA and then aggregated for that application and then further aggregated globally or aggregated with other similar applications, analyzed, ranked and/or valued by the TPA.

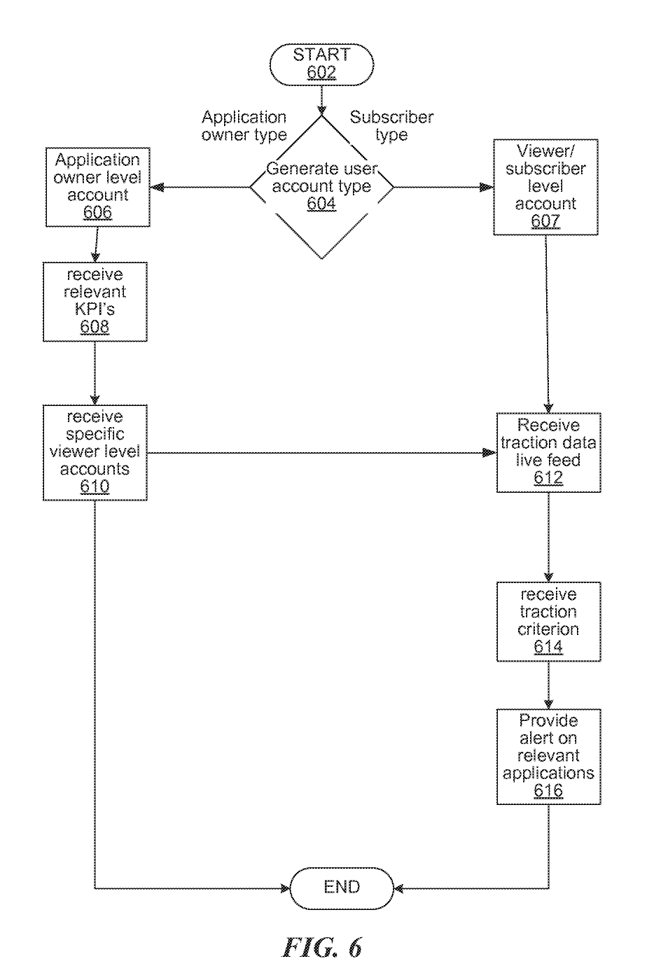

FIG. 6 is a flowchart illustrating permissions and actions for multiple levels of user accounts. In step 604, a user generates a user account with the TPA. Embodiments of user accounts include application owner accounts and viewer/subscriber accounts. In step 606, the user creates an application owner account. This step corresponds with step 403 of FIG. 4. The user registers an application with the TPA, acquires the API and implements the API in the owner's software application.

It may be beneficial to the owner(s) of software application(s) to have third parties (subscribers) such as potential investors who access the traction data. In step 607, such a viewer/subscriber creates an account. This level of account can be used by potential investors (“investing parties”). Investing parties may include, for example, institutional venture capitalists, angel investors, users representing corporate interests, or members of the interested public. Viewer level users are enabled to view the real-time live feed of traction data.

In step 608, the TPA receives relevant chosen KPI's from the application owner. Step 608 determines what sort of traction data is generated by the software application. In step 610, the TPA receives a list of chosen subscribers or viewers from the application owner. The chosen subscribers are granted access to the traction data associated with the owned software application.

The application owner user has numerous ways to specify viewer level users. Examples include selecting all viewer level users, viewer level users associated with particular companies or interests, viewer level users belonging to particular social groups, or selecting viewer users by name. Unselected viewer level users would not see the software application in the live feed of real-time traction data presented to those viewer level users. In step 612, the specific viewer level users receive the reports or the live feed of traction data pertaining to the software application.

In step 614, viewer level users are enabled to determine one or more traction criteria. The traction criteria can include relevant parameters and thresholds for traction data that interest the viewer. Examples include: thresholds for selected KPI's or combinations of KPI's that interest the viewer level user, comparing traction data for one or more software applications against aggregated traction data for several software applications aggregated either globally or segmented based on one or more criteria such as geography, industry, application, feature set, user demographic etc.

To place a value on a software application, the subscriber may compare traction data for one or more software applications against aggregated traction data for several software applications aggregated across all TPA registered applications or segmented based on one or more criteria such as geography, industry, application, feature set, user demographic etc.

The TPA enables subscribers to place a ranking or value on a software application. The ranks are used for feedback to a group or single owner of software application(s); and/or assess the effectiveness of the present system and/or method in ranking and valuing software applications.

In step 616, when a traction criterion is satisfied, for a given viewer/subscriber level user, the TPA sends an alert to that user. Through TPA generated reports, GUI dashboard or the real-time live feed, that viewer level user is provided the traction data that caused the alert, contact information, or investing information for the software application that triggered the alert.

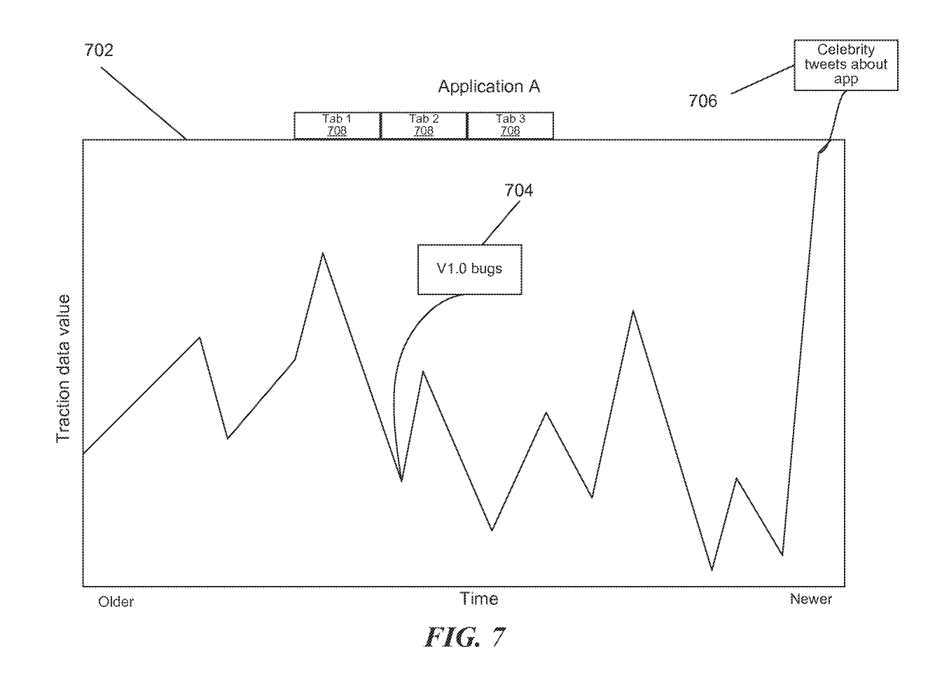

FIG. 7 is a chart diagram illustrating one embodiment of a real-time live feed 702 focusing on an individual application wherein an application owner has annotated the data 704, 706. The TPA (e.g. the TPA 228 of FIG. 2) displays a real-time live feed of traction data 702 on a website. In the example provided in FIG. 7, a specific application (e.g. Application A 210 of FIG. 2) is selected and displayed. This particular drilled-down real-time live feed 702 has aggregated traction data associated with a single application as opposed to a number of applications. The traction data is displayed as a single value or score on a graph.

When an application owner level account views this data, the TPA uses GUI elements to enable the application owner to add annotations to specific moments in time. These annotations provide explanation or context to trends in the traction data associated with the owner's application. Shown in FIG. 7 annotation 702 explains a downturn in traction data trends with buggy software in the application. Later in time, the application owner provides an annotation 704 to explain that a massive rise in popularity occurred when a celebrity tweeted about the application.

When a subscriber account selects the specific application out many applications included in an alternate embodiment of a real-time live feed (e.g. a live feed including data of many applications), the subscriber is directed to the drilled-down live feed 702 displayed in FIG. 7. GUI elements of the TPA then enable the subscriber to view the application owner's annotations 704, 706.

Alternate embodiments of the drilled-down live-feed 702 include multiple panes for different KPI's included in the traction data. Each pane is accessed by clicking tabs 708 to switch between different types of tracked traction data. The different panes enable a user to drill down further into explanations of trends.

While embodiments have been particularly shown and described, it will be understood by those skilled in the art that various changes in form and detail may be made therein without departing from the spirit and scope of the invention. Furthermore, as used herein, the term “computer” or “system” includes any data processing system or apparatus, including personal computers, servers, workstations, network computers, mainframe computers, routers, switches, personal data assistants, wearable computers, smartphones, telephones, kiosks, and any other system capable of processing, transmitting, receiving, capturing, sensing and/or storing data.

It will be appreciated that variations of the above disclosed and other features and functions, or alternatives thereof, can be desirably combined into many other different systems or applications. Also that various presently unforeseen or unanticipated alternatives, modifications, variations or improvements therein can be subsequently made by those skilled in the art, which are also intended to be encompassed by the present invention.

1. A method comprising:
publishing an application programming interface (API), for implementation by code in each of a plurality of software applications, for real-time collection and transmittal of software traction data, where each of the plurality of software applications is on a separate one of a plurality of startup business enterprises;
collecting, by code implementing the API in each of the plurality of software applications, traction data associated with each of the plurality of software applications, wherein for each of the software applications the traction data includes data representing recordable user actions related to the software application;
forwarding collected traction data in real-time, by the code implementing the API in each software application, over the Internet to a network server;
receiving, by the network server, the collected traction data associated with the plurality of software applications;
aggregating, by the network server, the collected traction data associated with the plurality of software applications into aggregate traction data;
publishing to a web site, by the network server, a live feed of the collected traction data associated with the plurality of software applications; and
enabling a plurality of potential investors in the startup enterprises to access, via the web site, the live feed of the collected traction data associated with the plurality of software applications, such that the collected traction data associated with each software application of the plurality of software application is separately accessible to the potential investors.

2. The method of claim 1, further comprising:
establishing a plurality of user account levels within and having access to the network server, the user accounts having associated users, the account levels including:
application owner; and
viewer;
enabling owners of the plurality of software applications to generate application owner level user accounts associated with the application owner level, each of the application owner level user accounts associated with an owned application; and
enabling the potential investors to generate user accounts of the plurality of user accounts associated with the viewer level, wherein the viewer level user accounts is enabled to access the live feed of the aggregate traction data.

3. The method of claim 2, further comprising:
enabling the viewer level of user accounts to establish account thresholds, the account thresholds setting minimum values associated with the traction data; and
sending alerts, by the network server, to a particular viewer level account when the traction data of a given software application of the plurality of applications exceeds the account threshold.

4. The method of claim 2, further comprising:
enabling application owner level of user accounts to opt-in the associated owned applications, wherein only opted-in applications are included in the live feed of traction data.

5. The method of claim 2, further comprising:
enabling each of the application owner level of user accounts to select one or more of the viewer level user accounts, wherein only selected viewer level accounts have access to the live feed of fraction data including the owned application associated with the selecting application owner level account.

6. The method of claim 1, further comprising:
collecting, by the network server, additional traction data from third-party analytics engines concerning one or more software applications of the plurality of applications;
analyzing and reconciling, by the network server, the additional traction data with the traction data collected by the analytics interface and thereby classifying the additional traction data as corroborating data, new data, and false data; and
augmenting, by the network server, the live feed of aggregate traction data with the new data.

7. A method comprising:
receiving, by a network server over a computer network, real-time traction data of a plurality of software applications, from a plurality of remote processing devices, the real-time traction data of each software application of the plurality of software applications having been individually collected by said software application;
creating, by the network server, a live feed of the received real-time traction data of the plurality of software applications; and
publishing, by the network server, the live feed of the real-time traction data of the plurality of software applications to a plurality of traction data subscribers via a computer network.

8. The method of claim 7, wherein the plurality of software applications are associated with a plurality of start-up business enterprises, and wherein the plurality of traction data subscribers include a plurality of self-declared potential investors in the start-up business enterprises.

9. The method of claim 7, wherein the received real-time traction data has been transmitted by an analytics interface integrated with the plurality of software applications, to the network server.

10. The method of claim 9, wherein the received real-time traction data has been transmitted by the analytics interface to the network server according to a predefined API.

11. The method of claim 7, further comprising:
detecting, by the network server, that the real-time traction data for a particular software application, of the plurality of software applications satisfies a predetermined traction criterion; and
in response to detecting that the real-time traction data for the particular software application satisfies the predetermined traction criterion:
generating, by the network server, an alert message related to the particular software application, and
sending the alert message to at least one of the plurality of fraction data subscribers.

12. The method of claim 7, further comprising:
storing metadata, by the network server, individually for a number of software applications of the plurality of software applications, each instance of the metadata comprising a list of specific subscribers preselected by the owner of a corresponding software application, of the number of software applications; and
filtering the live feed of the real-time traction data wherein real-time traction data associated with the given software application is published only to the specific subscribers indicated by the metadata.

13. The method of claim 7, wherein for each of the software applications the real-time traction data includes data representing any of:
user downloads of the software application from an application store;
user account creation associated with the software application;
user log-ins associated with the software application;
user account deactivation associated with the software application;
user purchases as processed by the software application;
user visits to a webpage running the software application;
user interactions with other users of the software application; or
application-specific recordable user actions.

14. The method of claim 7, wherein at least one of the software applications executes in the plurality of processing devices.

15. The method of claim 7, wherein at least one of the software applications executes in a device other than the plurality of processing devices.

16. A system comprising:
a network server receipt module configured to receive real-time traction data of a plurality of software applications, from a plurality of remote processing devices, the real-time traction data of each software application of the plurality of software applications having been individually collected by said software application;
a network server feed module configured to create a live feed of the received real-time traction data of the plurality of software applications; and
a network server publishing module configured to publish the live feed of the real-time traction data of the plurality of software applications to a plurality of traction data subscribers via a computer network.

17. The system of claim 16, further comprising:
an analytics interface integrated with each software application, of the plurality of software applications, thereby generating a plurality of instances of the analytics interface, wherein the analytics interface collects the real-time traction data and transmits the real-time traction date to the network server.

18. The system of claim 16, wherein the network server is configured to detect when the real-time traction data for a particular software application of the plurality of software applications satisfies a predetermined fraction criterion, and is further configured to respond to said detection by:
generating an alert message related to the particular software application, and
sending the alert message to at least one of the plurality of traction data subscribers.

19. The system of claim 16, wherein for each of the software applications the real-time traction data includes data representing any of:
user downloads of the software application from an application store;
user account creation associated with the software application;
user log-ins associated with the software application;
user account deactivation associated with the software application;
user purchases as processed by the software application;
user visits to a webpage running the software application;
user interactions with other users of the software application; or
application-specific recordable user actions.

20. The system of claim 16, wherein the network server is configured to store metadata individually for a number of software applications of the plurality of software applications, each instance of the metadata comprising a list of specific subscribers preselected by the owner of a corresponding software application, of the number of software applications; and further configured to filter the live feed of the real-time traction data wherein real-time traction data associated with the given software application is published only to the specific subscribers indicated by the metadata.
